(19) United States
(12) Patent Application Publication
(10) Pub. No.: US 2010/0123399 A1
(43) Pub. Date: May 20, 2010

(54) LED lighting system with bypass circuit for failed LED

(76) Inventors: Klaus Bollmann, Horseshoe Bay, TX (US); Tom C. Penick, Leander, TX (US)

Correspondence Address: RICK B. YEAGER, ATTORNEY, 10805 MELLOW LANE, AUSTIN, TX, 78759, US

(21) Appl. No.: 12/621,438

(22) Filed: Nov. 18, 2009

Related U.S. Application Data
(60) Provisional application No. 61/115,775, filed on Nov. 18, 2008.
(60) Provisional application No. 61/149,076, filed on Feb. 2, 2009.

(51) Int. Cl. H05B 37/02

(52) U.S. Cl. 315/122; 315/119

(57) ABSTRACT

A bypass circuit is provided for each LED in a series to permit continued operation with reduced lighting in the event of an LED failure. The bypass circuit is provided in parallel to the LED and comprises a Zener Diode provided in parallel to a thyristor. Upon LED failure, the voltage across the Zener Diode is increased thereby triggering the thyristor which is maintained in a triggered mode as long as current flows through the series circuit.

This application is related to U.S. Provisional Patent Application No. 61/115,775 filed Nov. 18, 2008, and claims the priority date of that provisional patent application; and is related to U.S. Provisional Patent Application No. 61/149,076 filed Dec. 14, 2008.

### BACKGROUND

1. Field of Invention

This application is related to LED lighting, and more specifically to a system and method for providing continued operation in the event that an LED in series with other LEDs fails.

2. Prior Art

Most LED lighting arrangements have a number of LEDs in series. Although LEDs, in general, are reliable for extended periods of time, failures are known to happen. If one LED fails and becomes an open circuit, then the others in series with that LED will also fail because no current can flow.

### SUMMARY OF INVENTION

The essence of the invention is to detect the failure of an LED and to shunt the open circuit LED so that the other LEDs can still function and produce the maximum possible light output. For example, if four LEDs are provided in series in a street light and one of the LED fails, one aspect of the current invention is that the remaining three operational LEDs would continue to provide light. Rather than causing a complete loss of light, the street light would provide 75% of normal light output.

A second aspect of the invention is that, at the same time, the minimum extra energy (close to none) is expended to shunt the non working LED. Thus, if the circuit was using, for example, 4 LEDs of 7 watts each and thereby consuming 28 watts all together, after failure of one LED the circuitry will still
a) operate with 3 remaining LEDs (automatically); and
b) consume ˜3×7 watts=21 watts as a result of the failure.

The cost of the solution is relatively low and it can also be applied to groups of LEDs as well as to each single LED.

### BRIEF DESCRIPTION OF DRAWINGS

FIG. 1A is a schematic of a single LED and bypass circuit.

FIG. 1B is a schematic of the LED and bypass circuit of FIG. 1 showing a first LED circuit portion and a second bypass circuit portion.

FIG. 2A is a schematic of a four LEDs and bypass circuits in series.

FIG. 2B is a schematic of the four LEDs and bypass circuits of FIG. 2A showing a normal current path when all four LEDs are functional.

FIG. 2C is a schematic of the four LEDs and bypass circuits of FIG. 2A showing a current path when one of the LEDs is non-functional.

### DESCRIPTION OF INVENTION

### Led with Bypass Circuit

The term “positive terminal” and “negative terminal” refer to any wire, circuit trace, or other connection to a power source and ground.

The term “thyristor” refers to a single component or to circuitry which provides the behavior of a thyristor.

The term “Zener Diode” refers to a single component or to circuitry which provides the behavior of a Zener Diode by having a first state with low voltage across the circuit, and a second state where increased voltage across the circuit triggers a thyristor.

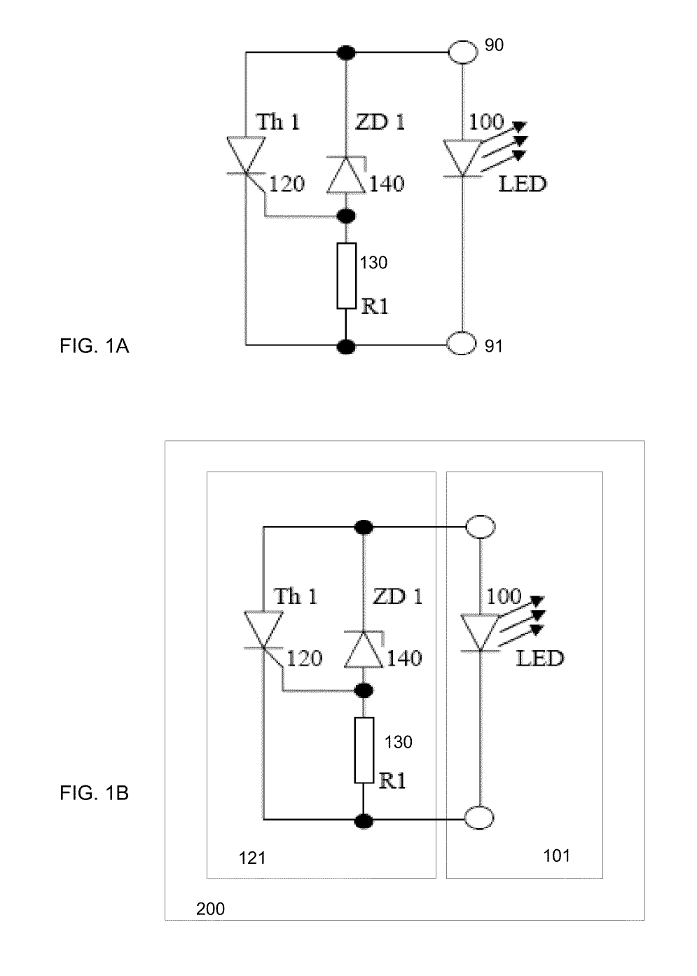

FIG. 1A is a schematic of a single LED and bypass circuit of one embodiment of the current invention. FIG. 1B is a schematic of the “LED and bypass circuit” 200 of FIG. 1 showing a first LED circuit portion 101 and a second bypass circuit portion 121.

The LED circuit portion 101 includes an LED 100 which is positioned between a positive terminal 90 and a negative terminal 91.

The bypass circuit portion 121 is provided in parallel to the LED circuit portion and includes a first portion with a Zener Diode 140 in series with a resistor 130; and a second portion with a thyristor 120.

When the LED is operational, the voltage across the Zener Diode 140 remains below its zener voltage, and the thyristor 120 is not triggered.

When an LED fails, the voltage across Zener Diode 140 increases above its zener voltage triggering the thyristor 120 which will remain triggered as long as current flows.

### DESCRIPTION OF INVENTION

### Continued Led Operation When One Led in a Series Fails

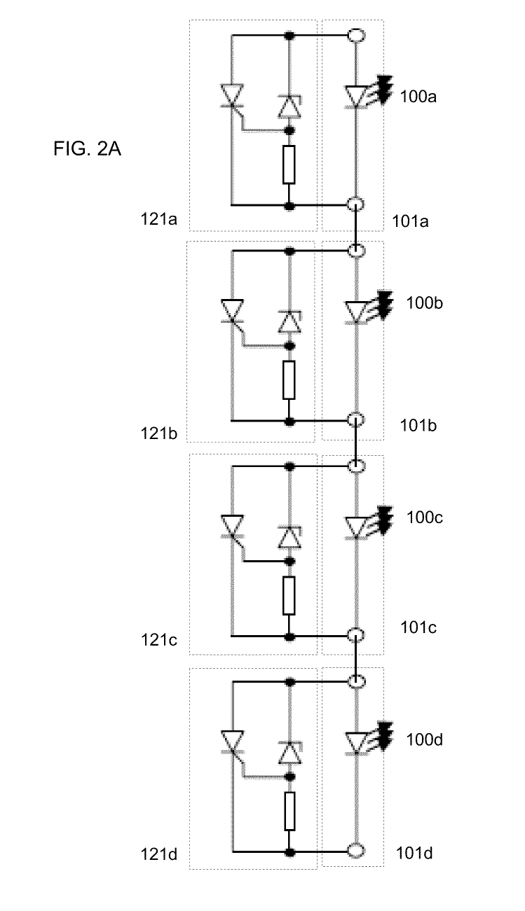

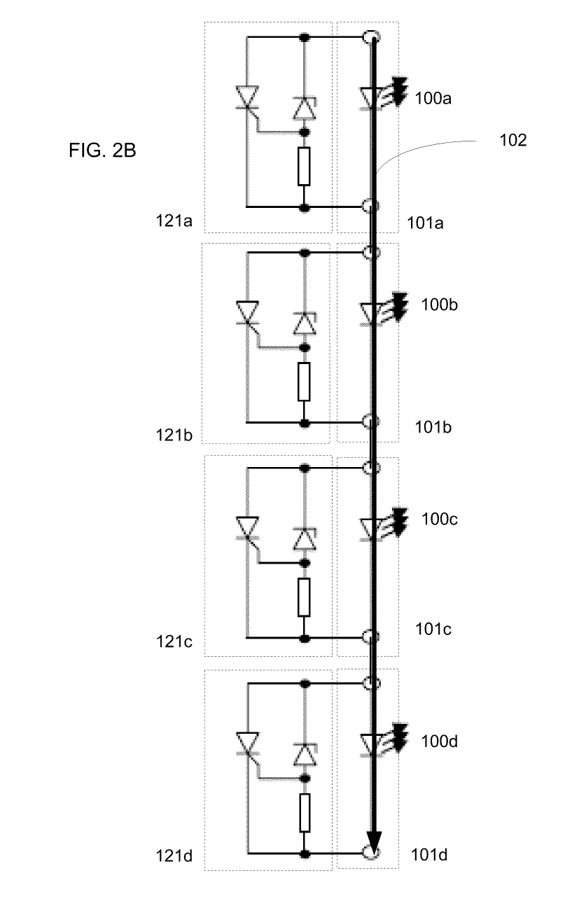

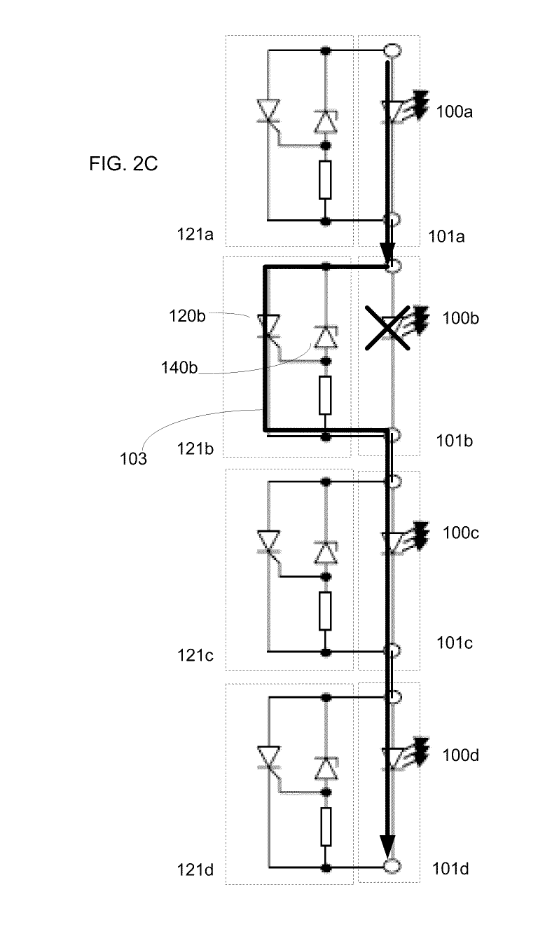

FIG. 2A is a schematic of a four LEDs 100a, 100b, 100c, and 100d and bypass circuits 121a, 121b, 121c, and 121d in series.

FIG. 2B is a schematic of the four LEDs and bypass circuits of FIG. 2A showing a normal current path 102 when all four LEDs are functional.

FIG. 2C is a schematic of the four LEDs and bypass circuits of FIG. 2A showing a current path 103 when LED 100b is non-functional. When LED 100b fails, the the voltage across Zener Diode 140b increases above its zener voltage triggering the thyristor 120b which will remain triggered as long as current flows.

A thyristor gets triggered by over-voltage on either the LED or the group of LEDs and shunts for either the cycle, in case of half cycle operation, or pulse width modulation, or the duration of the LED array being energized.

Benefits

One benefit of the current invention is safety-lights may get dimmer but not fail and still produce a safer environment rather than no light in mission critical applications.

The savings in maintenance when applied to applications such as street, car parking and path lights is large as maintenance can be scheduled rather than much more costly ad hoc repair.

### EXAMPLE 1

### Circuitry Provided With Each LED

In this example, the bypass circuit may be provided with each LED as a single unit.

### EXAMPLE 2

### Circuitry Provided as Integrated Circuit

In this example, the bypass circuit may be provided as an integrated circuit that is subsequently wired in parallel to each LED.

### EXAMPLE 3

### Discrete Components

In this example, the bypass circuit may be provided as discrete components, such as on a circuit board, that are subsequently wired in parallel to each LED.

### EXAMPLE 4

### Other Numbers of LEDs in Series

In the embodiment above, a series of 4 LEDs is provided. In other examples, other numbers of LEDs and bypass circuits may be provided in series.

What is claimed is:

1. An LED lighting system comprising
a first LED and bypass circuit, the first LED and bypass circuit comprising
an LED circuit portion having an LED between a positive and a negative terminal, and
a bypass circuit portion provided in parallel to the LED circuit portion, the bypass circuit portion having a Zener Diode provided in parallel to a thyristor.

2. The LED lighting system of claim 1 wherein
the LED circuit portion and the bypass circuit portion are provided as a single component.

3. The LED lighting system of claim 1 wherein
the bypass circuit portion is provided as an integrated circuit.

4. The LED lighting system of claim 1 wherein
the bypass circuit portion is provided as discrete components.

5. The LED lighting system of claim 1 wherein
the LED and the discrete components of the bypass circuit portion are mounted on a circuit board.

6. The LED lighting system of claim 1 further comprising
a second LED and bypass circuit, the second LED and bypass circuit comprising
an LED circuit portion having an LED between a positive and a negative terminal, and
a bypass circuit portion provided in parallel to the LED circuit portion, the bypass circuit portion having a Zener Diode provided in parallel to a thyristor.

6. The LED lighting system of claim 1 further comprising
a second LED and bypass circuit, the second LED and bypass circuit comprising
an LED circuit portion having an LED between a positive and a negative terminal, and
a bypass circuit portion provided in parallel to the LED circuit portion, the bypass circuit portion having a Zener Diode provided in parallel to a thyristor.

7. The LED lighting system of claim 6 wherein
the first LED and bypass circuit is provided in series with the second LED and bypass circuit.

8. The LED lighting system of claim 7 further comprising
the third and a fourth LED and bypass circuit provided in series with the first and second LED and bypass circuits, the third and a fourth LED and bypass circuit each comprising
an LED circuit portion having an LED between a positive and a negative terminal, and
a bypass circuit portion provided in parallel to the LED circuit portion, the bypass circuit portion having a Zener Diode provided in parallel to a thyristor.

9. A method of controlling a plurality of LEDs in series, the method comprising
providing a plurality of LEDs in a series circuit,
providing a bypass circuit portion in parallel to each LED, the bypass circuit portion having a Zener Diode provided in parallel to a thyristor;
operating the plurality of LEDs in a full-capability mode where each LED is operational; and
upon the failure of an LED, shunting the failed LED with the bypass circuit, thereby providing current to all functional LEDs in the series circuit.

10. The method of claim 9 wherein shunting the failed LED with the bypass circuit further comprises
increasing the voltage across the Zener Diode;
triggering the thyristor; and
maintaining the thyristor in a triggered mode as long as current flows through the series circuit.
